(19) United States
(12) Patent Application Publication
(10) Pub. No.: US 2013/0276492 A1
(43) Pub. Date: Oct. 24, 2013

(54) HIGH SECURITY LOCK CORE STRUCTURE

(71) Applicant: TIEN-KAO LIU, PINGTUNG COUNTY (TW)

(72) Inventor: TIEN-KAO LIU, PINGTUNG COUNTY (TW)

(21) Appl. No.: 13/868,171

(22) Filed: Apr. 23, 2013

Related U.S. Application Data
(63) Continuation-in-part of application No. 13/019,389, filed on Feb. 2, 2011.

(51) Int. Cl. E05B 27/00

(52) U.S. Cl. CPC E05B 27/0057
USPC 70/492

(57) ABSTRACT

A lock core includes a casing having a space defined axially therein and multiple top bead holes defined radially in the casing. The casing has at least one side bead hole and a side bead unit is located in at least one side bead hole. The side bead unit has a side bead and a resilient member mounted to outside of the side bead. The side bead has a neck and a flange. A core is located in the space and has bottom bead holes and a keyhole which communicates with the bottom bead holes which communicate with the top bead holes. Each of the bottom bead holes has a stepped portion formed therein which is located corresponding to the flange of the side bead. The depth of each of the stepped portions is not larger than the total length of the neck and the flange.

### REFERENCE TO RELATED APPLICATION

This application is being filed as a Continuation-in-Part of application Ser. No. 13/019,389, filed 2 Feb. 2011, currently pending.

### FIELD OF THE INVENTION

The present invention relates to a lock core structure, and more particularly, to a high security lock core structure which has a side bead unit and the bottom bead holes have stepped portions so as to have higher safety feature and save manufacturing cost.

### BACKGROUND OF THE INVENTION

A conventional lock core structure is disclosed in U.S. Pat. No. 4,403,486. Referring to FIGS. 1 and 2, the U.S. Pat. No. 4,403,486 generally includes a casing 10 with a core 20 located therein, wherein the casing 10 has top bead holes 101 and the core 20 has bottom bead holes 201 which are in communication with the top bead holes 101. Each of the bottom bead holes 201 has a bottom bead 30 located therein and each bottom bead 30 has a recess 301 defined in the top thereof. The casing 10 has multiple side bead holes 102 and the side bead holes 102 have a side bead unit 40a, 40b located therein. The side bead unit 40a has a first side bead 401 a, a second side bead 402a and a first resilient member 403a. The first side bead 401a has an assistance bead 404a inserted therein. The first resilient member 403a is located at one end of the second side bead 402a. The side bead unit 40b has a third side bead 401b and a second resilient member 402b which is located at one end of the third side bead 401b.

When the core 20 is rotated, the bottom bead holes 201 are in alignment with the side bead holes 102. When an incorrect key such as a universal key or an L-shaped tool is used, the top end of the bottom beads 30 cannot be in alignment with the opening of the bottom bead holes 201, so that the second side beads 402a are pushed by the first resilient members 403a, and the first side beads 401a are located in the bottom bead holes 201, and the assistance beads 404a are located between the core 20 and the casing 10. As shown in FIG. 2, the third side beads 401b and the second resilient members 402b are restricted in the side bead holes 102. If the bottom bead holes 201 are located in alignment with the side bead holes 102, and the top ends of the bottom beads 30 are not in alignment with the openings of the bottom bead holes 201, the third side beads 401b are pushed by the second resilient members 402b and drop into the bottom bead holes 201.

However, the assistance beads 404a located between the core 20 and the casing 10 cannot be ensure the safety of the lock, when the bottom beads 30 are picked to move the first side beads 401a and the second side beads 402a to move a certain distance, the end faces of the first side beads 401a and the assistance beads 404a are located in alignment with the openings of the bottom bead holes 201. In other words, the core 20 can be rotated freely relative to the casing 10 so that the lock is unlocked. Besides, even if the third side beads 401b are located in the bottom bead holes 201, because the second resilient members 402 are located at the end faces of the third side beads 401b, and the bottom beads 30 are moved back, and that the third bottom beads 401b are completely located in the bottom bead holes 201. When the second resilient members 402b are deformed by a force from outside of the lock, the core 20 can be rotated and the lock is unlocked.

Furthermore, the casing 10 has to be thick enough to accommodate the first side beads 401a and the second side beads 402a of the side bead units 40a which has different lengths. This makes the lock to be bulky and has higher manufacturing cost.

The present invention intends to provide a high security lock core structure to improve the shortcomings of the conventional lock.

### SUMMARY OF THE INVENTION

The present invention relates to a lock core and comprises a casing having a space defined axially therein and multiple top bead holes defined radially in the casing. The casing has at least one side bead hole communicating with the space and a side bead unit is located in at least one side bead hole. The side bead unit has a side bead and a resilient member mounted to outside of the side bead. The side bead has a neck and a flange. A core is located in the space and has bottom bead holes defined radially therethrough and a keyhole is defined axially therein which communicates with the bottom bead holes which communicate with the top bead holes. Each of the bottom bead holes has a stepped portion formed therein which is located corresponding to the flange of the side bead. The depth of each of the stepped portions is not larger than the total length of the neck and the flange.

Preferably, the thickness of a wall of the space in the casing is 2 to 2.5 mm.

Preferably, the depth of the stepped portion is 0.5 mm.

Preferably, the total length of the side bead is 1 to 1.5 mm.

Preferably, a gap is formed between the conjunction area between the core and the casing. The gap is 0.15 to 0.25 mm.

Preferably, the at least one side bead hole has a shoulder formed therein which is located close to outside of the casing.

Preferably, the resilient member is biased between the shoulder and the flange.

Preferably, the resilient member is a cone-shaped member.

Preferably, the casing has two side bead holes defined therethrough.

Preferably, a filling hole is defined in the casing and communicates with the space. The filling hole is located diametrically relative to the at least one side bead hole. The side bead unit is installed in the at least one side bead hole via the filling hole. A cover seals the filing hole.

The primary object of the present invention is to provide a lock core which has side bead units and the bottom bead holes have stepped portions. When the core is stroke, hit or picked maliciously, even if the core is rotated to align the bottom bead holes with the side bead holes, the side beads are biased by the resilient members to stop the flanges by the stepped portions. The side beads are stocked between the core and the casing such that the core cannot be continuously rotated to reinforce the safety feature of the lock. The thickness of the casing is reduced when compared with the conventional locks so as to reduce the manufacturing cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a partial side cross sectional view of a conventional lock;

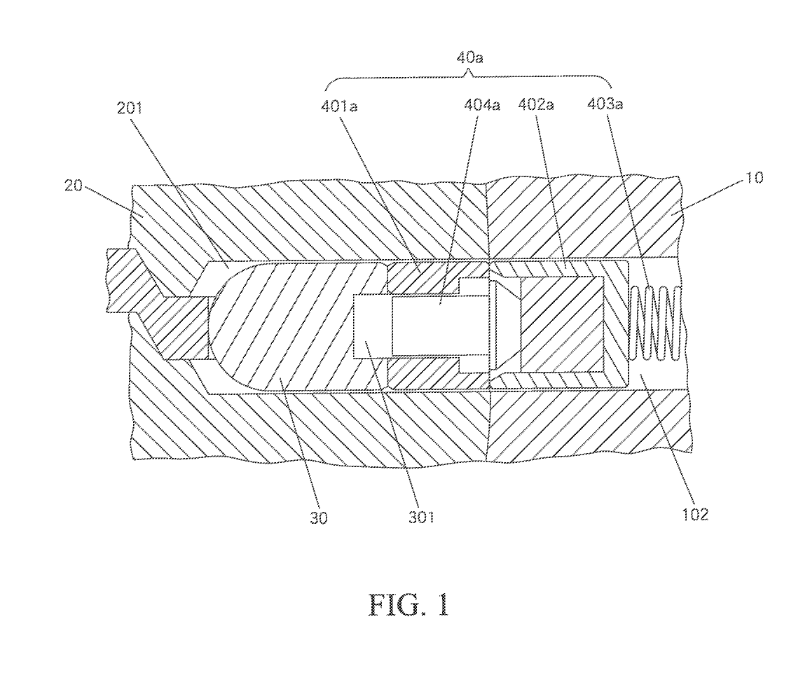

FIG. 2 is a partial end cross sectional view of a conventional lock;

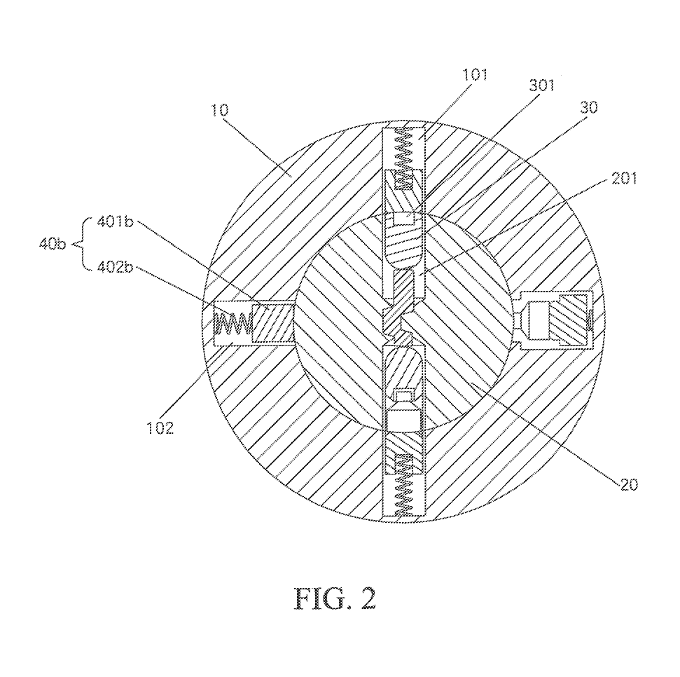

FIG. 3 is an exploded view to show the lock of the present invention;

FIG. 4 is a perspective view to show the lock of the present invention;

FIG. 5 is a cross sectional view, taken along line A-A in FIG. 4;

FIG. 6 is a cross sectional view, taken along line A-A in FIG. 4, when a correct key is used;

FIG. 7 is a cross sectional view, taken along line A-A in FIG. 4, to show the core is rotated when a correct key is used;

FIG. 8 is a cross sectional view, taken along line A-A in FIG. 4, to show the core is rotated when an incorrect key is used;

FIG. 9 is a cross sectional view, taken along line A-A in FIG. 4, to show that the side bead unit is locked, and

FIG. 10 is an enlarged view to show the status of the disclosure in FIG. 9.

### DETAILED DESCRIPTION OF THE PREFERRED EMBODIMENT

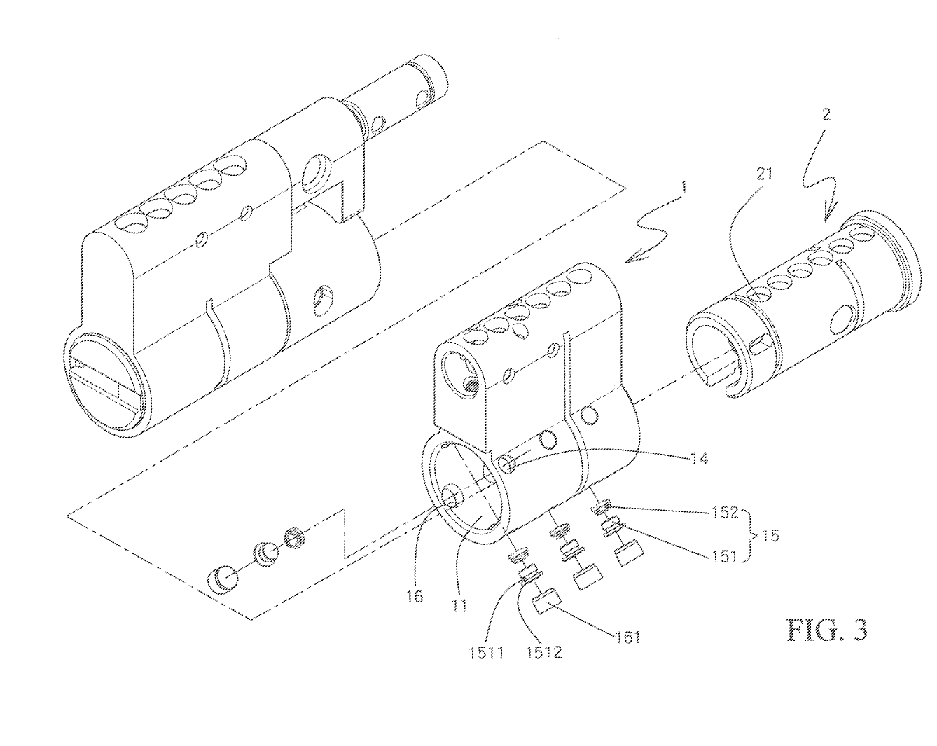

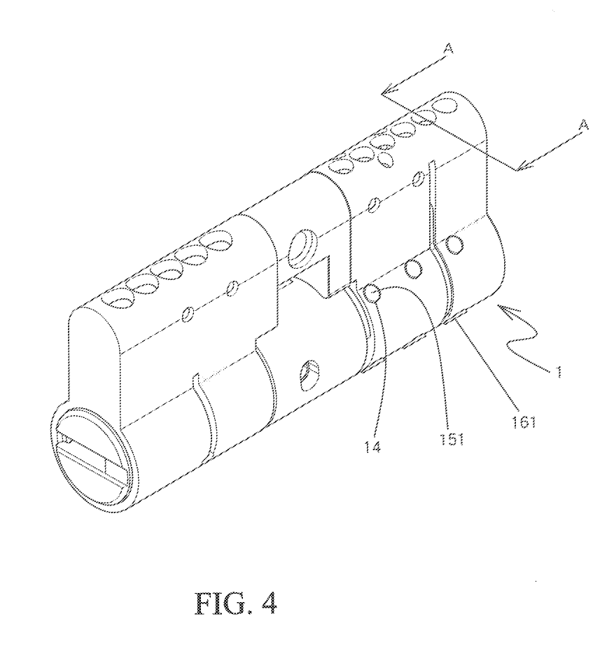

Referring to FIGS. 3 to 6, the lock core of the present invention comprises a casing 1 having a space 11 defined axially therein and multiple top bead holes 12 are defined radially in the casing 1. Each of the top head boles 12 has a top bead unit 13 received therein. The casing 1 has side bead holes 14 defined therethrough which communicate with the space 11. The side bead holes 14 are located in pairs and each have a side bead unit 15 located therein which has a side bead 151 and a resilient member 152. The side bead 151 has a neck 1511 and a flange 1512. The resilient member 152 is mounted to outside of the side bead 151. Multiple filling holes 16 are defined in the casing 1 and communicate with the space 11. The filling holes 16 each are located diametrically relative to the side bead holes 14. Each filling hole 16 is sealed by a cover 161. The side bead holes 14 each have a shoulder 141 formed therein which is located close to outside of the casing 1.

A core 2 located in the space 11 of the casing 1 and has bottom bead holes 21 defined radially therethrough and a keyhole 22 defined axially therein. The keyhole 22 communicates with the bottom bead holes 21 which communicate with the top bead holes 12. Each of the bottom bead holes 21 has a bottom bead unit 23 received therein and a stepped portion 211 is formed in each of the bottom bead holes 21. The stepped portion 211 is located corresponding to the flange 1512 of the side bead 151. The depth of each of the stepped portions 211 is not larger than the total length of the neck 1511 and the flange 1512.

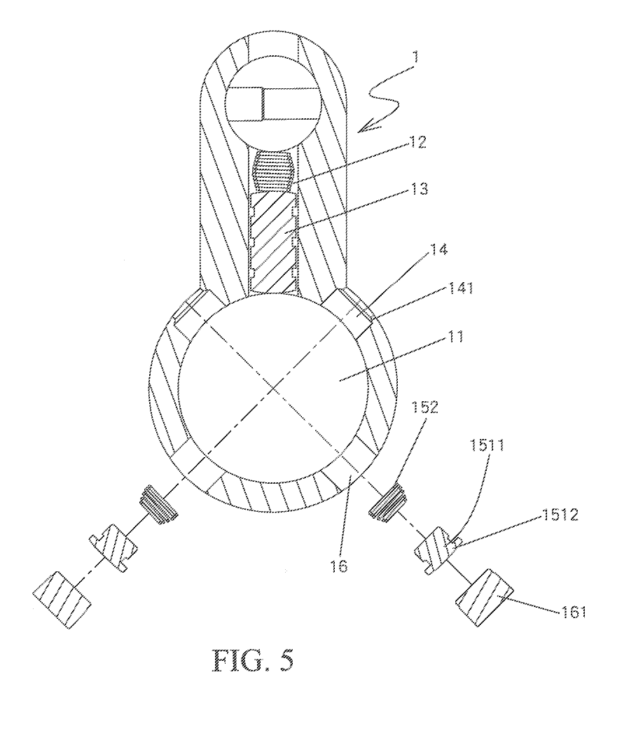

As shown in FIG. 5, the side bead unit 15 is installed in each of the side bead holes 14 via the filling hole 16 corresponding thereto. Each filling hole 16 is then sealed by the cover 161. The installation starts from the installing the resilient member 152 and the side bead 151 from the filling hole 16, and the resilient member 152 which is a cone-shaped member is mounted to the side bead 151. The resilient member 152 is inserted from the side bead hole 14 and biased between the neck 141 and the flange 1512. The side bead holes 14 are defined through the casing 1 so that the end opposite to the flange 1512 protrudes beyond the outside of the casing 1, so that the thickness of the casing 1 does not have to be made to meet with the length of the side bead 151. Therefore, the casing 1 can be made thinner. The core 2 is then inserted into the space 11 to restrict the side bead units 15 in the side bead holes 14. The covers 161 finally seal the filling holes 16.

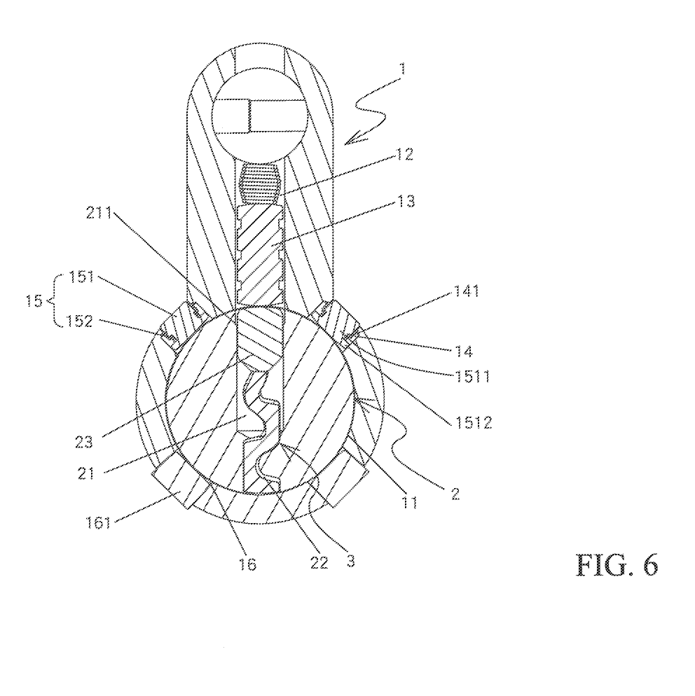

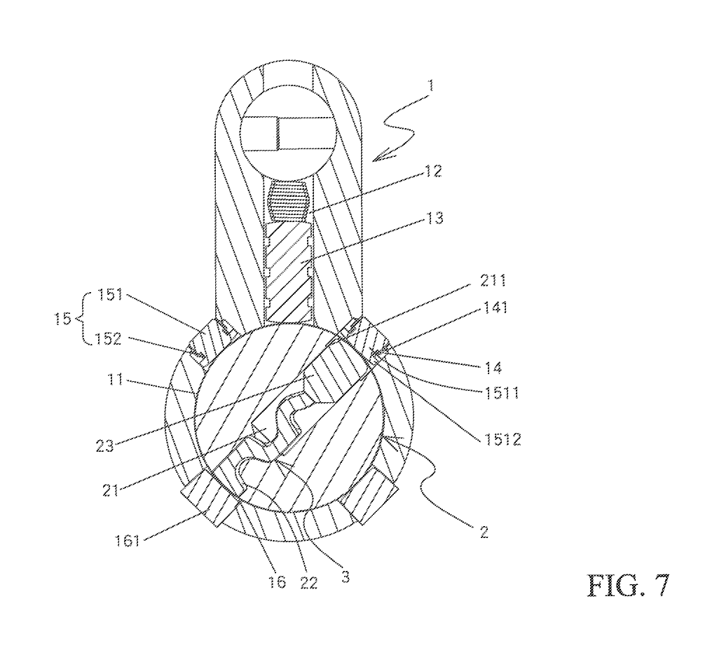

As shown in FIGS. 6 and 7, when the correct key 3 is inserted into the keyhole 22, the bottom bead units 23 are properly pushed so that the end faces of the bottom bead units 23 are in flush with the openings of the bottom bead holes 21, so that the core 2 is rotated by rotating the correct key 3. Therefore the bottom bead holes 21 are moved to be alignment with the side bead holes 14, the top ends of the bottom bead units 23 contact the end faces of the side beads 151. The side bead units 15 are still in the side bead holes 14 so that the core 2 can be rotated by the correct key 3 to unlock the lock.

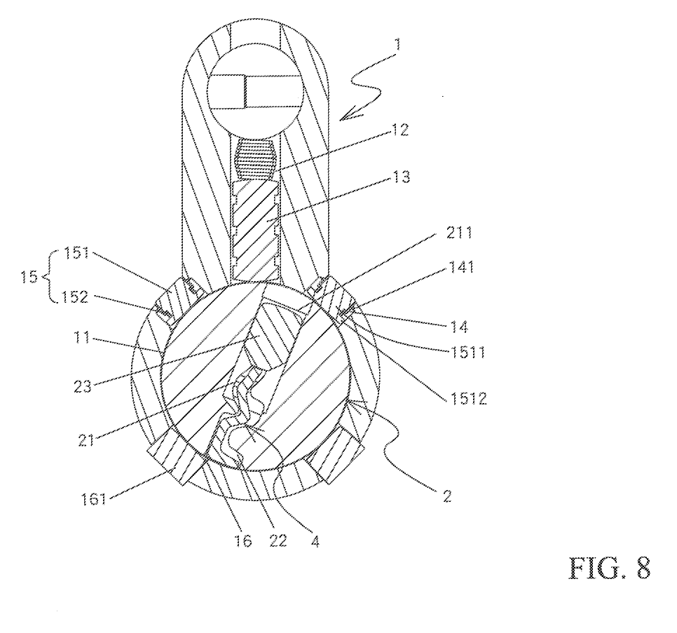

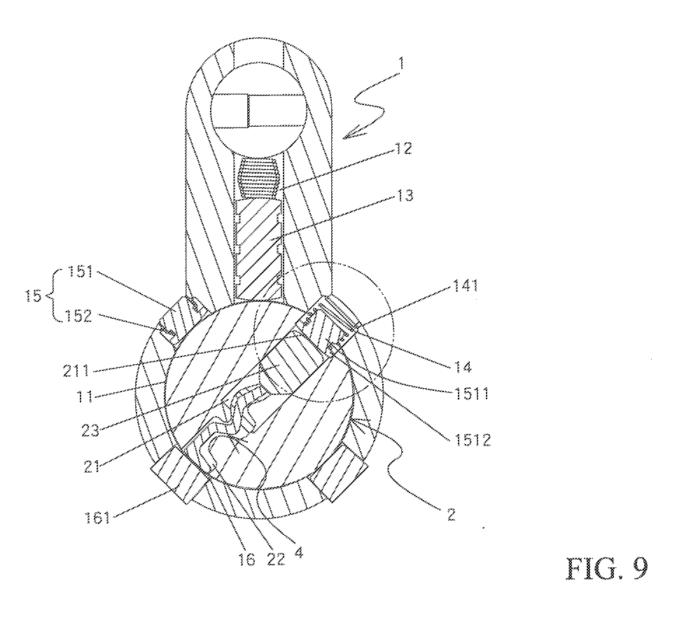

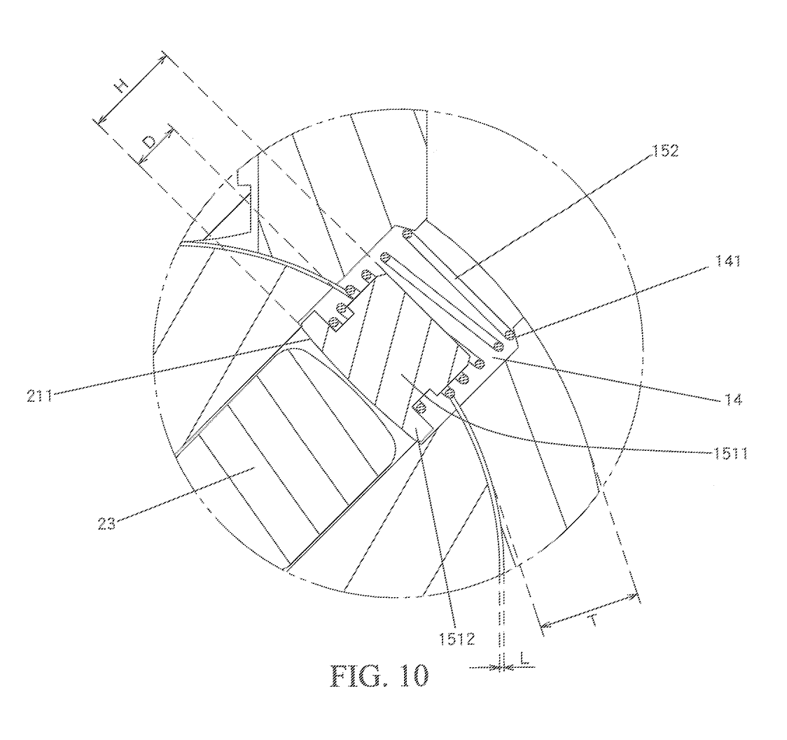

Referring to FIGS. 8 to 10, when an incorrect key such as the universal key 4 or an L-shaped tool is used to hit and pick the lock and try to rotate the core 2, the serrated side of the incorrect key 4 cannot move the end faces of the bottom bead units 23 to be in flush with the openings of the bottom bead holes 21. During the picking action to the bottom bead units 23, a distance is formed between the bottom bead units 23 and the openings of the bottom bead holes 21. When rotating the core 2 by the incorrect key 4, the bottom bead holes 21 are moved to be alignment with the side bead holes 14, the side beads 151 are pushed by the resilient members 152, as shown in FIG. 9, the flanges 1512 are stopped by the stepped portions 211. Because the depth of the stepped portion 211 is not larger than the total length of the neck 1511 and the flange 1512, the side beads 151 are stocked at the conjunction areas between the core 2 and the casing 1. Therefore, the core 2 cannot be rotated continuously. The incorrect key 4 is stocked in the keyhole 22 and cannot be pulled out, and the bottom bead units 23 cannot be picked. There is no space to allow the L-shaped tool to be inserted into the lock to avoid the lock from being stricken by the L-shaped tool.

In a preferable embodiment, the thickness “T” of the wall of the space 11 in the casing 1 is 2 to 2.5 mm. The depth “D” of the stepped portion 211 is 0.5 mm. The total length “H” of the side bead 151 is 1 to 1.5 mm. A gap “L” is formed between the conjunction area between the core 2 and the casing 1, the gap is 0.15 to 0.25 mm.

The present invention provides the neck 1511 and the flange 1512 on each of the side beads 151, and the bottom bead holes 21 have stepped portions 211, so that when the lock is hit or picked, the core 2 perhaps is able to be rotated by the incorrect key 4, the end faces of the bottom bead units 23 cannot be in flush with the openings of the bottom bead holes 21. Once the bottom bead holes 21 are moved to be alignment with the side bead holes 14, the flanges 1512 are stopped by the stepped portions 211, and the side beads 151 are stocked at the conjunction area between the core 2 and the casing 1. The incorrect key 4 and the core 2 are both locked and cannot be rotated. The lock has higher safety feature and the thinner thickness of the casing 1 saves manufacturing cost.

While we have shown and described the embodiment in accordance with the present invention, it should be clear to those skilled in the art that further embodiments may be made without departing from the scope of the present invention.

What is claimed is:

1. A lock core comprising:
a casing having a space defined axially therein and multiple top bead holes defined radially in the casing, the casing has at least one side bead hole which communicates with the space, the at least one side bead hole having a side bead unit located therein which has a side bead and a resilient member, the side bead having a neck and a flange, the resilient member mounted to outside of the side bead, and
a core located in the space of the casing and having bottom bead holes defined radially therethrough and a keyhole defined axially therein, the keyhole communicating with the bottom bead holes which communicate with the top bead holes, each of the bottom bead holes having a stepped portion formed therein which is located corresponding to the flange of the side bead, a depth of each of the stepped portions being not larger than a total length of the neck and the flange.

2. The lock core as claimed in claim 1, wherein a thickness of a wall of the space of the casing is 2 to 2.5 mm.

3. The lock core as claimed in claim 1, wherein the depth of the stepped portion is 0.5 mm.

4. The lock core as claimed in claim 1, wherein a total length of the side bead is 1 to 1.5 mm.

5. The lock core as claimed in claim 1, wherein a gap is formed between a conjunction area between the core and the casing, the gap is 0.15 to 0.25 mm.

6. The lock core as claimed in claim 1, wherein the at least one side bead hole has a shoulder formed therein which is located close to outside of the casing.

7. The lock core as claimed in claim 6, wherein the resilient member is biased between the shoulder and the flange.

8. The lock core as claimed in claim 1, wherein the resilient member is a cone-shaped member.

9. The lock core as claimed in claim 1, wherein the casing has two side bead holes defined therethrough.

10. The lock core as claimed in claim 1, wherein a filling hole is defined in the casing and communicates with the space, the filling hole is located diametrically relative to the at least one side bead hole, the side bead unit is installed in the at least one side bead hole via the filling hole, a cover seals the filing hole.
